(19) United States
(12) Patent Application Publication
(10) Pub. No.: US 2013/0037058 A1
(43) Pub. Date: Feb. 14, 2013

(54) HYDROCHLOROFLUOROOLEFIN-BASED CLEANING COMPOSITIONS

(71) Applicant: Laurent Abbas, Narberth, PA (US)

(72) Inventor: Laurent Abbas, Narberth, PA (US)

(73) Assignee: Arkema France, Colombes (FR)

(21) Appl. No.: 13/521,562

(22) PCT Filed: Jan. 13, 2011
(86) PCT No.: PCT/FR11/50060

§ 371 Date: Jul. 11, 2012

(30) Foreign Application Priority Data
Jan. 22, 2010 (FR) 1050415

(51) Int. Cl. C11D 17/00; B08B 3/04

(52) U.S. Cl. 134/10; 510/412; 510/365; 510/273; 510/244; 510/109

(57) ABSTRACT

The invention relates to the use of a liquid composition including 1-chloro-3,3,3-trifluoropropene and 1,2-transdichloroethylene for cleaning solid surfaces, the 1-chloro-3,3,3-trifluoropropene and the 1,2-transdichloroethylene being at least 99 wt % of the composition. The invention also relates to a liquid composition containing 1-chloro-3,353-trifluoropropene and 1,2-transdichloroethylene, the 1-chloro-3,3,34triluoropropene and 1,2-transdichloroethylene being at least 99 wt % of the composition and the weight ratio of the 1-chloro-3,3,3″trifluoropropene over the 1,2-transdichloroethylene being between 57:43 and 65:35, preferably between 58:42 and 63:37, and more preferably between 59:41 and 61:39.

### FIELD OF THE INVENTION

The present invention relates to hydrochlorofluoroolefin-based cleaning compositions and to the use of these compositions for a cleaning process.

### TECHNICAL BACKGROUND

1,1,2-Trichloro-1,2,2-trifluoroethane (CFC-113) has been widely used in industry for the cleaning and degreasing of various solid surfaces (metal parts, glasses, plastics, composites) for which it is required that impurities, in particular of organic nature, be absent or at the very least present in the lowest possible residual content. CFC-113 was particularly well suited to this use due to its nonaggressive nature with regard to the materials used. For example, this product has been used in the field of the manufacture of printed circuits in order to remove the residues from the substances used to improve the quality of the welds (denoted by the term of welding flux). This removal operation is denoted in the field by the term of “defluxing”.

However, the use of CFC-113 presents an environmental problem of damage to the ozone layer and this use is thus from now on widely banned.

A number of replacement solutions have been provided, based in particular on fluoroolefins (HFOs) and in particular hydrochlorofluoroolefins (HFCOs or HCFOs).

For example, the documents US 2006/0142173 and US 2009/0318323 describe the use of various fluoroolefins as cleaning agent and in particular 1-chloro-3,3,3-trifluoropropene (HFCO-1233zd).

The document WO 2009/140231 also describes the use of HFCO-1233zd for the cleaning of solid surfaces and in particular for defluxing. The document also mentions the possibility of using a number of coagents chosen from a list which comprises in particular trans- 1,2-dichloroethylene (TDCE). The only cleaning composition example comprising HFCO-1233zd and TDCE which is mentioned in the document is a ternary mixture, the third compound being methyl acetate.

The document WO 2009/089511 describes very generally compositions based on fluoroolefins and their use in the most varied fields, including cleaning. HFCO-1233zd is one of the fluoroolefins described. Furthermore, the document mentions the possibility of combining HFCO-1233zd with TDCE (in particular according to ratios by weight of 25:75, 50:50 and 75:25) in applications other than cleaning, namely in the field of blowing agents, the deposition of silicone (use of silicone oil as solvent) and the extraction of fragrances. As regards the cleaning field, the document provides for the use of HFCO-1233zd, alone or in combination with methanol.

HFCO-1233zd is a compound which is relatively effective for cleaning applications and it has the advantage of being relatively harmless to the environment. In particular, it exhibits a low GWP. However, the effectiveness of HFCO-1233zd for the cleaning of solid surfaces still remains unsatisfactory, at least in some applications, this being the case whether it is used alone or in ternary combination with TDCE and methyl, acetate.

There thus exists a real need to improve the existing cleaning processes and more specifically to develop more effective cleaning agents (in particular more effective with regard to certain greases) which exhibit advantageous physicochemical properties (in particular in terms of GWP).

### SUMMARY OF THE INVENTION

The invention relates first to the use of a liquid composition comprising 1-chloro-3,3,3-trifluoropropene and trans- 1,2-dichloroethylene for the cleaning of solid surfaces, the 1-chloro-3,3,3-trifluoropropene and trans-1,2-dichloroethylene representing at least 99% by weight of the composition.

According to one embodiment, the liquid composition is evaporated during the cleaning.

According to one embodiment, the abovementioned use is for the defluxing of electronic boards or for the degreasing of metal parts, glasses, plastics or composite materials, said degreasing preferably comprising the cleaning of a grease or oil chosen from greases or oils of mineral or organic type, with or without fillers, and more particularly preferably chosen from mineral greases comprising lithium/calcium or complex lithium as fillers.

According to one embodiment, the ratio by weight of the 1-chloro-3,3,3-trifluoropropene to the trans-1,2-dichloroethylene in the liquid composition is:
between 1:99 and 99:1; or
between 10:90 and 90:10; or
between 20:80 and 80:20; or
between 30:70 and 70:30; or
between 40:60 and 60:40; or
between 45:55 and 55:45;
and is preferably approximately 50:50.

According to one embodiment, at least 80% by weight of the 1-chloro-3,3,3-trifluoropropene is in the trans form; preferably at least 90% by weight, more particularly preferably at least 95% by weight, advantageously at least 98% by weight and ideally essentially all of the 1-chloro-3,3,3-trifluoropropene is in the trans form.

Another subject matter of the invention is a process for cleaning solid surfaces comprising bringing the solid surfaces into contact with a composition comprising 1 -chloro-3,3,3 -trifluoropropene and trans-1,2-dichloroethylene, the 1-chloro-3,3,3-trifluoropropene and the trans-1,2-dichloroethylene representing at least 99% by weight of the composition.

According to one embodiment, the solid surfaces to be cleaned are mechanical or electronic components contaminated by a welding flux or metal parts, glasses, plastics and/or composite materials contaminated by grease or oil, the grease or oil preferably being chosen from greases or oils of mineral or organic type, with or without fillers, and more particularly preferably chosen from mineral greases comprising lithium/calcium or complex lithium as fillers.

According to one embodiment, the above mentioned process comprises:
providing a liquid cleaning composition comprising 1-chloro-3,3,3-trifluoropropene and trans-1,2-dichloroethylene, the 1-chloro-3,3,3-trifluoropropene and the trans-1,2-dichloroethylene representing at least 99% by weight of the liquid cleaning composition; and
bringing the solid surfaces into contact with the liquid cleaning composition.

According to one embodiment, the abovementioned process comprises:
providing a liquid cleaning composition comprising 1-chloro-3,3,3-trifluoropropene and trans-1,2-dichloroethylene, the l-chloro-3,3,3-trifluoropropene and the trans-1,2-dichloroethylene representing at least 99% by weight of the liquid cleaning composition;
producing a gaseous cleaning composition by heating the liquid cleaning composition;
bringing the solid surfaces into contact, with the gaseous cleaning composition;
optionally recovering and condensing the gaseous cleaning composition.

According to one embodiment, the ratio by weight of the 1-chloro-3,3,3-trifluoropropene to the trans-1,2-dichloroethylene in the liquid cleaning composition is:
between 1:99 and 99:1; or
between 10:90 and 90:10; or
between 20:80 and 80:20; or
between 30:70 and 70:30; or
between 40:60 and 60:40; or
between 45:55 and 55:45;
and is preferably approximately 50:50.

According to one embodiment, at least 80% by weight of the 1-chloro-3,3,3-trifluoropropene in the liquid cleaning composition is in the trans form; preferably at least 90% by weight, more particularly preferably at least 95% by weight, advantageously at least 98%) by weight and ideally essentially all of the 1-chloro-3,3,3-trifluoropropene is in the trans form.

Another subject matter of the invention is a liquid composition comprising 1-chloro-3,3,3-trifluoropropene and trans-1,2-dichloroethylene, the 1-chloro-3,3,3-trifluoropropene and trans-1,2-dichloroethylene representing at least 99% by weight of the composition and the ratio by weight of the 1-chloro-3,3,3-trifluoropropene to the trans-1,2-dichloroethylene being between 57:43 and 65:35, preferably between 58:42 and 63:37, more particularly preferably between 59:41 and 61:39.

According to one embodiment of the use described above, the liquid composition is as described in the preceding paragraph. According to an embodiment of the method described above, the liquid cleaning composition is as described in the preceding paragraph.

The present invention makes it possible to overcome the disadvantages of the state of the art. It provides more particularly an improved cleaning method based on the use of a more effective cleaning agent, in particular more effective with regard to certain greases, which exhibits advantageous physicochemical properties (in particular a low GWP).

This is accomplished by virtue of the use of a binary combination of HFCO-1233zd and TDCE as cleaning agent.

According to certain specific embodiments, the invention also exhibits one or preferably several of the advantageous characteristics listed below.
The invention makes it possible to improve the properties of cleaning greases with respect to the state of the art. In particular, the compositions according to the invention are more effective than HFCO-1233zd used alone or than HFCO-1233zd used as a ternary mixture with TDCE and methyl acetate, in particular with regard to mineral greases comprising lithium/calcium as filler (greases for resistance to high pressures) or comprising complex lithium as filler (greases for resistance to high loads and high speeds).
In comparison with the HFCO-1233zd/methanol cleaning composition described in the document WO 2009/089511, the invention makes it possible to improve the effectiveness of the cleaning while using less toxic products. In this regard, it should be emphasized that methanol is a toxic product which is not suitable for use in an open environment (vapor phase cleaning).
When the HFCO-1233zd:TDCE ratio by weight is between 57:43 and 65:35, preferably between 58:42 and 63:37 and more particularly preferably between 59:41 and 61:39, the compositions according to the invention exhibit reduced risks of ignition when they are used as cleaning agents, in particular for vapor phase cleaning, in comparison with a composition in which the FIFCO-1233zd:TDCE ratio by weight is lower (and for example is approximately 50:50). In addition, the cleaning power of the composition has a tendency to decrease (at least with regard to certain greases, such as mineral greases comprising lithium/calcium as filler or complex lithium as filler) when the proportion of HFCO-1233zd increases and exceeds a certain threshold. Consequently, the binary HFCO-1233zd and TDCE compositions in which the HFCO-1233zd:TDCE ratio by weight is between 57:43 and 65:35, preferably between 58:42 and 63:37 and more particularly preferably between 59:41 and 61:39 constitute a particularly good compromise since they exhibit both low risks of ignition when used for vapor phase cleaning and satisfactory cleaning properties, in particular with regard to certain greases, such as mineral greases comprising lithium/calcium as filler or complex lithium as filler.
The invention provides for the use of cleaning compositions exhibiting a boiling point which is in practice compatible with the constraints related to the cleaning application (in particular in the vapor phase) and in particular the handling (filling of the vessels), transportation (risk of swelling or rupture of the containers) and use (performance of the refrigerated unit necessary for the condensation of the vapor phase) constraints. In particular, the boiling point of the cleaning compositions in the context of the invention is higher than that of HFCO-1233zd used alone, which is approximately 18° C. (such a value presenting a problem with regard to the constraints recalled above).
The invention provides for the use of cleaning compositions exhibiting a low GWP and more generally having a relatively low negative impact on the environment.

### DESCRIPTION OF THE EMBODIMENTS OF THE INVENTION

The invention is now described in more detail and without implied limitation in the following description.

All the percentages shown refer to values by weight, unless otherwise mentioned.

### Cleaning Process

The invention provides for the use of binary 1-chloro-3,3,3-trifluoropropene (HFCO-1233zd) and trans-1,2-dichloroethylene (TDCE) compositions in the context of the cleaning of solid surfaces.

The solid surfaces to be cleaned can be electronic boards contaminated by a welding flux, in which case the cleaning process is a defluxing process.

The solid surfaces to be cleaned can also be metal parts, glasses, plastics and/or composite materials contaminated with grease or oil, in which case the cleaning process is a degreasing process, The greases or oils can be of mineral or organic type, with or without fillers, These include greases, the high viscosity (greater than 85 mmz/s at 40° C.) of which makes them difficult to clean. They are in particular mineral greases comprising lithium/calcium as filler (greases for resistance to high pressures) or comprising complex lithium as filler (greases for resistance to high loads and high speeds). The invention makes it possible to particularly effectively clean these greases.

The cleaning process is based on bringing the solid surfaces to be cleaned into contact with the binary HFCO-1233zd and TDCE composition. The composition can be in the liquid phase and/or in the vapor phase during the contacting operation. Preferably, the contacting operation is carried out in the vapor phase for greater effectiveness. Thus, the process comprises:
providing the cleaning composition in the liquid state,
bringing the cleaning composition to the vapor state by heating;
bringing the solid surfaces into contact with the cleaning composition;
recovering the cleaning composition and bringing the cleaning composition to the liquid state by cooling,

Typically, the process is carried out in a plant comprising at least two vessels, namely a vaporization vessel and a recovery vessel. The vaporization vessel is filled with cleaning composition in the liquid form. The solid surfaces to be cleaned are placed above the vaporization vessel. The cleaning composition of the vaporization vessel is healed and partially evaporated. The cleaning composition, in the vapor form, is thus brought into contact with the solid surfaces to be cleaned. Materials (greases or others) are carried away during the cleaning and fall into the vaporization vessel, where they are recovered by settling.

Cooling means are positioned above the solid surfaces to be cleaned and make it possible to condense the cleaning composition, The condensed cleaning composition is collected in the recovery vessel, which in its turn feeds the vaporization vessel. A make-up supply of each compound of the cleaning composition (HFCO-1233zd and TDCE) or a make-up supply of the composition itself is generally provided.

Rinsing of the solid surfaces with the same cleaning composition (in the liquid phase) or with another solvent can be provided.

### Cleaning Compositions

The term “binary composition” is understood to mean a composition which comprises exclusively or virtually exclusively HFCO-1233zd and TDCE. In. particular, the composition comprises a proportion by weight of impurities or additives of less than or equal to 1%, preferably of less than or equal to 0.5%. indeed even of less than or equal to 0.1%.

The HFCO-1233zd is preferably in its trans form, which exhibits the advantage of being less toxic than the cis form. The trans form advantageously represents at least 80% by weight of the HFCO-1233zd, preferably at least 90% by weight, more particularly preferably at least 95%o by weight, for example at least 98% by weight. Ideally, essentially all of the HFCO-1233zd is in the trans form.

The HFCO-1233zd and TDCE composition used in the context of the cleaning process according to the invention can comprise, in its liquid form (the percentages being expressed in values by weight):
a) from 1% of HFCO-1233zd to 99% of HFCO-1233zd, and from 1% of TDCE to 99% of TDCE;
b) from 10% of HFCO-1233zd to 90% of HFCO-1233zd, and from 10% of TDCE to 90% of TDCE;
c) from 20% of HFCO-1233zd to 80% of HFCO-1233zd, and from 20% of TDCE to 80% of TDCE;
d) from 30%) of HFCO-1233zd to 70% of HFCO-1233zd, and from 30% of TDCE to 70% of TDCE;
e) from 40% of HFCO-1233zd to 60% of HFCO-1233zd, and from 40% of TDCE to 60% of TDCE;
f) from 45% of HFCO-1233zd to 55% of HFCO-1233zd, and from 45% of TDCE to 55% of TDCE; and
g) for example approximately 50% of HFCO-1233zd and 50% of TDCE.

In particular, the composition comprising approximately 50% of FIFCO-1.233zd and 50% of TDCE exhibits excellent cleaning properties, in particular with regard to certain greases, such as mineral greases comprising lithium/calcium as filler or complex lithium as filler. It in addition exhibits a boiling point of approximately 30° C., which is satisfactory with regard to the practical constraints related to the application in cleaning.

The compositions which comprise approximately 50% or less than 50% of HFCO-1233zd are particularly effective for the cleaning of solid metal surfaces as a result of the high cleaning power of TDCE; in addition, they exhibit a high boiling point which is particularly convenient for the application in cleaning. On the other hand, the compositions comprising at least 75% of HFCO-1233zd, preferably at least 80%, at least 85%, at least 90% or at least 95% are particularly well suited to the cleaning of solid plastic or composite surfaces, given that HFCO-1233zd is more compatible than TDCE with plastics,

From the viewpoint of the flammability, the liquid composition comprising approximately 50% of HFCO-1233zd and 50% of TDCE does not exhibit a flash point. However, this composition is not azeotropic. Consequently, in the context of a cleaning process (and in particular in the context of a vapor-phase cleaning process as described above), the relative proportions by weight of HFCO-1233zd and of TDCE in the liquid composition can vary if the amount of liquid composition itself varies, in the event of a mishap (escape of product, failure of the cooling means, and the like). In such a case, the final liquid composition may then exhibit a flash point, that is to say may be flammable.

In particular, the final liquid composition obtained after evaporation of 90% of the weight, of an initial liquid composition comprising 50% of HFCO-1233zd and 50% of TDCE is flammable. It is more generally the same for any final liquid composition obtained after evaporation of 90% of the weight of an initial liquid composition comprising a proportion of HFCO-1233zd of less than or equal to 56%.

On the other hand, this is not the case for an initial HFCO-1233zd and TDCE liquid composition comprising a proportion of HFCO-1233zd of greater than or equal to 57% and in particular for a liquid composition comprising:
h) from 57% of HFCO-1233zd to 65% of HFCO-1233zd, and from 35% of TDCE to 43% of TDCE;
i) from 58% of HFCO-1233zd to 63% of HFCO-1233zd, and from 37% of TDCE to 42% of TDCE;
j) from 59% of HFCO-1233zd to 61% of HFCO-1233zd, and from 39% of TDCE to 41% of TDCE; and
k) for example approximately 60% of HFCO-1233zd and approximately 40% of TDCE.

Consequently, the above HFCO-1233zd and TDCE compositions h) to k) make it possible to obtain greater safety of the cleaning, in particular in the vapor phase, in the event of a mishap resulting in a decrease in level of liquid composition (in particular in the vaporization vessel). In addition, these compositions h) to k) exhibit satisfactory cleaning properties, in particular with regard to mineral greases comprising lithium/calcium as filler or complex lithium as filler, given that a greater concentration of HFCO-1233zd (for example a concentration of greater than or equal to 70% of HFCO-1233zd) results in a deterioration in the cleaning performance of the composition, in particular with regard to the abovementioned greases.

### EXAMPLES

The following examples illustrate the invention without limiting it.

### Example 1

### Cleaning Properties

Various liquid cleaning compositions were tested according to the following protocol:

Polished and cleaned test specimens made of stainless steel (of 316L type), with dimensions of 30×10 mm, were weighed with an accuracy of 0.1 mg, A small amount of grease was deposited on the surface of these test specimens. The test specimens covered with grease were weighed in order to determine the weight of grease present.

The test specimens were then immersed for 5 min in a beaker containing a cleaning composition maintained at 20° C., and dried in the open air for 5 min. After this treatment, the test specimens were again weighed in order to determine the percentage of grease removed by the cleaning composition. The results are expressed by the mean value of 3 tests.

Various types of greases were tested, namely:
Grease A: mineral grease comprising lithium/ calcium as filler;
Grease B: mineral grease comprising lithium as filler;
Grease C: water-resistant mineral grease comprising lithium as filler.

Various liquid cleaning compositions were tested, namely:
50/50 Composition: 50% of trans-HFCO-1233zd and 50% of TDCE;
60/40 Composition: 60% of trans-HFCO-1233zd and 40% of TDCE;
70/30 Composition; 70% of trans-HFCO-1233zd and 30% of TDCE;
80/20 Composition: 80% of trans-HFCO-1233zd and 20% of TDCE;
1233zd Composition: 100% of trans-HFCO-1233zd;
Ternary Composition: 67% of trans-HFCO-1233zd, 17% of TDCE and 16% of methyl acetate.

The results obtained are summarized in table 1 below.

TABLE 1
Percentage of grease removed according
to the cleaning composition used

| | Grease A | Grease B | Grease C |
|---|---|---|---|
| 50/50 Composition | 94 | 95 | 81 |
| 60/40 Composition | 67 | 91 | 77 |
| 70/30 Composition | 61 | 84 | 73 |
| 8.0/2.0 Composition | 56 | 65 | 54 |
| 1233zd Composition | 43 | 54 | 45 |
| Ternary Composition | 60 | 92 | 55 |

It is found that all the binary HFCO-1233zd/TDCE compositions tested have better performances than HFCO-1233zd alone on grease A, grease B and grease C, and have better performances than the ternary HFCO-1233zd/ TDCE/methyl acetate composition at least on greases A and C. The binary composition comprising 50% of HFCO-1233zd and 50% of TDCE is characterized by excellent cleaning properties on greases A, B and C, and the binary composition comprising 60% of HFCO-1233zd and 40% of TDCE is characterized by excellent cleaning properties at least on greases B and C. The binary compositions comprising 70% of HFCO-1233zd and 30% of TDCE or 80% of HFCO-1233zd and 20% of TDCE are characterized by a relatively lower effectiveness on all the greases, with respect to the binary composition comprising 60% of HFCO-1233zd and 40% of TDCE.

### Example 2

### Flammability

The flammability of various liquid binary trans-HFCO-1233zd and TDCE compositions was determined in accordance with the standard ASTM D-3828, both on the compositions as such and on the compositions obtained after evaporation of 90% of the weight of said liquid compositions.

The results obtained are summarized in table 2 below,

TABLE 2
Determination of the flammability of the cleaning compositions

| | | Flash point after |
|---|---|---|
| | Flash point of the | evaporation of 90% |
| | composition itself | of the composition |
| 45% HFCO-1233zd + | None | −10° C. |
| 55% TDCE | | |
| 50% HFCO-1233zd + | None | −9.5° C. |
| 50% TDCE | | |
| 55% HFCO-1233zd + | None | −9.5° C. |
| 45% TDCE | | |
| 57% HFCO-1233zd + | None | None |
| 43% TDCE | | |
| 62% HFCO-1233zd + | None | None |
| 38% TDCE | | |
| 70% HFCO-1233zd + | None | None |
| 30% TDCE | | |
| 80% HFCO-1233zd + | None | None |
| 20% TDCE | | |

It is found that the binary HFCO-1233zd/TDCE compositions comprising at least 57% of HFCO-1233zd remain nonflammable, even after evaporation of 90% of their weight. Consequently, these compositions exhibit better guarantees of safety in the context of a cleaning process, in particular in the vapor phase, than the compositions comprising less than 57% of HFCO-1233zd

1-5. (canceled)

6. A process for cleaning solid surfaces comprising contacting the solid surfaces with a liquid composition comprising 1-chloro-3,3,3-trifluoropropene and trans-1,2-dichloroethylene, wherein the 1-chloro-3,3,3-trifluoropropene and the trans-1,2-dichloroethylene comprising at least 99% by weight of the liquid composition.

7. The process as claimed in claim 6, in which the solid surfaces to be cleaned are components contaminated by a welding flux.

8 (canceled)

9. The process as claimed in claim 6, further comprising:
heating the liquid cleaning composition to produce a gaseous cleaning composition; and
contacting the solid surfaces with the gaseous cleaning composition; and
optionally recovering and condensing the gaseous cleaning composition.

10. The process as claimed in claim 6, in which the ratio by weight of the 1-chloro-3,3,3-trifluoropropene to the trans-1,2-dichloroethylene in the liquid cleaning composition is between 1:99 and 99:1.

11. The process as claimed in claim 6, in which at least 80% by weight of the 1-chloro-3,3,3-trifluoropropene in the liquid cleaning composition is in the trans form.

12. A liquid composition comprising 1-chloro-3,3,3-trifluoropropene and trans-1,2-dichloroethylene, the 1chloro-3,3,3-trifluoropropene and trans- 1,2-dichloroethylene representing at least 99% by weight, of the composition and the ratio by weight of the 1-chloro-3,3,3-trifluoropropene to the trans-1,2-dichloroethylene being between 57:43 and 65:35.

13-14. (canceled)

15. The process as claimed in claim 12, in which the ratio by weight of the 1-chloro-3,3,3-trifluoropropene to the trans-1,2-dichloroethylene being between 58:42and 63:37.

16. The process as claimed in claim 12, in which the ratio by weight of the 1-chloro-3,3,3-trifluoropropene to the trans-1,2-dichloroethylene being between 59:41and 61:39.

17. The process as claimed in claim 6, in which the ratio by weight of the 1-chloro-3.3,3-trifluoropropene to the trans-1,2-dichloroethylene in the liquid cleaning composition is between 10:90 and 90:10.

18. The process as claimed in claim 6, in which the ratio by weight of the 1-chloro-3,3,3-trifluoropropene to the trans-1,2-dichloroethylene in the liquid cleaning composition is between 20:80 and 80:20.

19. The process as claimed in claim 6, in which the ratio by weight of the 1-chloro-3,3,3-trifluoropropene to the trans-1,2-dichloroethylene in the liquid cleaning composition is between 30:70 and 70:30.

20. The process as claimed in claim 6, in which the ratio by weight of the 1-chloro-3,3,3-trifluoropropene to the trans-1,2-dichloroethylene in the liquid cleaning composition is between 40:60 and 60:40.

21. The process as claimed in claim 6, in which the ratio by weight of the 1-chloro-3,3,3-trifluoropropene to the trans-1,2-dichloroethylene in the liquid cleaning composition is between 45:55 and 55:45.

22. The process as claimed in claim 6, in which the ratio by weight of the 1-chloro-3,3,3-trifluoropropene to the trans-1,2-dichloroethylene in the liquid cleaning composition is approximately 50:50.

23. The process as claimed in claim 6, in which at least 90% by weight of the 1-chloro-3,3,3-trifluoropropene in the liquid cleaning composition is in the trans form.

24. The process as claimed in claim 6, in which at least 95% by weight of the 1-chloro-3,3,3-trifluoropropene in the liquid cleaning composition is in the trans form.

25. The process as claimed in claim 6, in which at least 98% by weight of the 1-chloro-3,3,3-trifluoropropene in the liquid cleaning composition is in the tons form.

26. The process as claimed in claim 6, in which at least essentially all of the 1-chloro-3,3,3-trifluoropropene in the liquid cleaning composition is in the trans form.

27. The process as claimed in claim 6, in which the solid surfaces to be cleaned are metal, glasses, plastics and/or composite materials contaminated by grease or oil,

28. The process of claim 26 wherein said grease or oil is selected from the group consisting of mineral type oils and organic type oils, with or without fillers.
